(19) United States
(12) Patent Application Publication
(10) Pub. No.: US 2023/0071810 A1
(43) Pub. Date: Mar. 9, 2023

(54) SYSTEM AND METHOD FOR PROVIDING SPATIOTEMPORAL COSTMAP INFERENCE FOR MODEL PREDICTIVE CONTROL

(71) Applicant: Honda Motor Co., Ltd., Tokyo (JP)

(72) Inventors: Keuntaek LEE, San Jose, CA (US); David F. ISELE, San Jose, CA (US); Sangjae BAE, San Jose, CA (US)

(21) Appl. No.: 17/568,951

(22) Filed: Jan. 5, 2022

Related U.S. Application Data
(60) Provisional application No. 63/240,123, filed on Sep. 2, 2021.

(51) Int. Cl. G05B 13/04; G06N 3/08

(52) U.S. Cl. CPC G05B 13/048; G06N 3/08

(57) ABSTRACT

A system and method for providing spatiotemporal costmap inference for model predictive control that includes receiving dynamic based data and environment based data to determine observations and goal information associated with an ego agent and a traffic environment. The system and method also include training a neural network with the observations and goal information and determining an optimal path of the ego agent based on at least one spatiotemporal costmap. The system and method further include controlling the ego agent to autonomously operate based on the optimal path of the ego agent.

### CROSS-REFERENCE TO RELATED APPLICATION

This application claims priority to U.S. Provisional Application Ser. No. 63/240,123 filed on Sep. 2, 2021, which is expressly incorporated herein by reference.

### BACKGROUND

Objective functions for autonomous driving often require balancing safety, efficiency, and smoothness amongst other concerns. It may be difficult to autonomously produce driver behavior so that it appears natural and interpretable to other traffic participants. While formulating such an objective is often non-trivial, the final result may produce behaviors that are unusual and difficult to interpret for other traffic participants, which in turn, may have an impact on autonomously navigating a vehicle in various driving scenes.

### BRIEF DESCRIPTION

According to one aspect, a computer-implemented method for providing spatiotemporal costmap inference for model predictive control that includes receiving dynamic based data and environment based data to determine observations and goal information associated with an ego agent and a traffic environment. The computer-implemented method also includes training a neural network with the observations and goal information. At least one spatiotemporal costmap is output by the neural network based on the observations and goal information. The computer-implemented method additionally includes determining an optimal path of the ego agent based on the at least one spatiotemporal costmap. The computer-implemented method further includes controlling the ego agent to autonomously operate based on the optimal path of the ego agent.

According to another aspect, a system for providing spatiotemporal costmap inference for model predictive control that includes a memory storing instructions when executed by a processor cause the processor to receive dynamic based data and environment based data to determine observations and goal information associated with an ego agent and a traffic environment. The instructions also cause the processor to train a neural network with the observations and goal information. At least one spatiotemporal costmap is output by the neural network based on the observations and goal information. The instructions additionally cause the processor to determine an optimal path of the ego agent based on the at least one spatiotemporal costmap. The instructions additionally cause the processor to control the ego agent to autonomously operate based on the optimal path of the ego agent.

According to yet another aspect, a non-transitory computer readable storage medium storing instruction that when executed by a computer, which includes a processor perform a method that includes receiving dynamic based data and environment based data to determine observations and goal information associated with an ego agent and a traffic environment. The computer-implemented method also includes training a neural network with the observations and goal information. At least one spatiotemporal costmap is output by the neural network based on the observations and goal information. The computer-implemented method additionally includes determining an optimal path of the ego agent based on the at least one spatiotemporal costmap. The computer-implemented method further includes controlling the ego agent to autonomously operate based on the optimal path of the ego agent.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a schematic view of an exemplary system for providing spatiotemporal costmap inference for model predictive control according to an exemplary embodiment of the present disclosure;

FIG. 2 is a schematic overview of a spatiotemporal costmap learning methodology executed by the predictive control application 106 according to an exemplary embodiment of the present disclosure;

FIG. 3 is a process flow diagram for determining observations and goals that are to be input to the neural network according to an exemplary embodiment of the present disclosure;

FIG. 4 is a process flow diagram of a method for determining an optimal control policy that is based on determined by spatiotemporal costmap inference according to an exemplary embodiment of the present disclosure; and

FIG. 5 is a process flow diagram of a method for providing spatiotemporal costmap inference for model predictive control according to an exemplary embodiment of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus can also be a vehicle bus that interconnects components inside a vehicle using protocols such as Media Oriented Systems Transport (MOST), Controller Area network (CAN), Local Interconnect Network (LIN), among others.

“Computer communication”, as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “disk”, as used herein can be, for example, a magnetic disk drive, a solid-state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

A “memory”, as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

A “module”, as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discreet logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

An “operable connection”, or a connection by which entities are “operably connected”, is one in which signals, physical communications, and/or logical communications may be sent and/or received. An operable connection may include a wireless interface, a physical interface, a data interface and/or an electrical interface.

A “processor”, as used herein, processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

A “vehicle”, as used herein, refers to any moving vehicle that is capable of carrying one or more human occupants and is powered by any form of energy. The term “vehicle” includes, but is not limited to: cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” may refer to an electric vehicle (EV) that is capable of carrying one or more human occupants and is powered entirely or partially by one or more electric motors powered by an electric battery. The EV may include battery electric vehicles (BEV) and plug-in hybrid electric vehicles (PHEV). The term “vehicle” may also refer to an autonomous vehicle and/or self-driving vehicle powered by any form of energy. The autonomous vehicle may or may not carry one or more human occupants. Further, the term “vehicle” may include vehicles that are automated or non-automated with pre-determined paths or free-moving vehicles.

A “value” and “level”, as used herein may include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value or level of X may be given as a percentage between 0% and 100%. In other cases, the value or level of X could be a value in the range between 1 and 10. In still other cases, the value or level of X may not be a numerical value, but could be associated with a given discrete state, such as “not X”, “slightly x”, “x”, “very x” and “extremely x”.

### I. System Overview

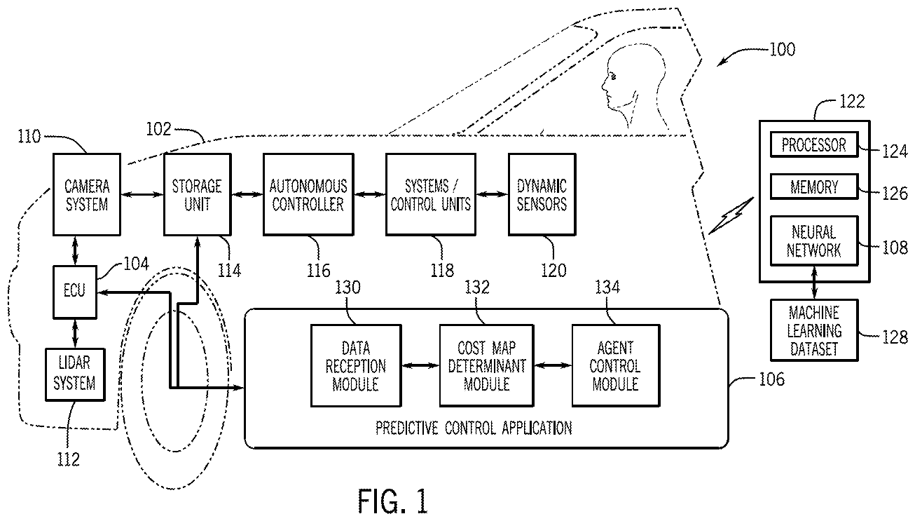

Referring now to the drawings, wherein the showings are for purposes of illustrating one or more exemplary embodiments and not for purposes of limiting same, FIG. 1 is a schematic view of an exemplary system for providing spatiotemporal costmap inference for model predictive control according to an exemplary embodiment of the present disclosure. The components of the system 100, as well as the components of other systems, hardware architectures, and software architectures discussed herein, may be combined, omitted, or organized into different architectures for various embodiments.

Generally, the system 100 includes an ego agent 102 that includes an electronic control unit (ECU) 104 that executes one or more applications, operating systems, agent system and subsystem user interfaces, among others. The ECU 104 may also execute a Spatiotemporal Costmap Inference Model Predictive Control Application (predictive control application) 106 that may be configured to train a neural network 108 based on processing of a spatiotemporal costmap. The spatiotemporal costmap may be based on cost functions that may be learned at a plurality of time steps. The cost functions may pertain to an operation of the ego agent 102 in one or more types of traffic environments of the ego agent 102. The costmaps may be utilized to process an optimal control policy that is associated with a projected operation of the ego agent 102 in a traffic environment that includes one or more traffic agents.

The ego agent 102 may include, but may not be limited to, a vehicle, a motorcycle, a motorized bicycle/scooter, a construction vehicle, an aircraft, and the like that may be traveling within the traffic environment of the ego agent 102 that may include one or more traffic agents. The traffic environment of the ego agent 102 may include a predetermined vicinity that may surround the ego agent 102 and may include one or more roadways, pathways, taxiways, and the like upon which the ego agent 102 may be traveling in addition to one or more traffic agents.

The one or more traffic agents may include, but may not be limited to, additional vehicles (e.g., automobiles, trucks, buses), pedestrians, motorcycles, bicycles, scooters, construction/manufacturing vehicles/apparatus (e.g., movable cranes, forklift, bulldozer), aircraft, and the like that may be located within and traveling within the traffic environment of the ego agent 102. The traffic environment may also include traffic infrastructure that may include, but may not be limited to, traffic lights (e.g., red, green, yellow), traffic signage (e.g., stop sign, yield sign, crosswalk sign), roadway markings (e.g., crosswalk markings, stop markings, lane merge markings), and/or additional roadway attributes (e.g., construction barrels, traffic cones, guardrails, concrete barriers, and the like).

In an exemplary embodiment, the predictive control application 106 may input observations and goals associated with the ego agent 102 and the traffic environment that are determined based on dynamic based data and environment based data that is received by the predictive control application 106 to train a neural network 108. Based on the training of the neural network 108, the predictive control application 106 may be configured to learn cost functions that pertain to the operation of the ego agent 102 and the behavior of human operator's of one or more traffic agents that are being operated within the traffic environment of the ego agent 102 at respective time steps. Each cost function may explain demonstrated behavior pertaining to a human operation of the ego agent 102 and/or human operation of one or more traffic agents within the traffic environment to consider future states of the traffic agents that are located within the traffic environment.

Accordingly, as human operators make decisions considering other agent's future states and avoiding any potential overlap between the trajectory paths of the agents, the predictive control application 106 aims to learn such decisions implicitly in the form of a cost function. In one or more embodiments, the predictive control application 106 represents the cost function as an image (map). The visual representation of the cost function may be output to provide a quick and intuitive analysis for both humans and real-time optimal control and/or reinforcement control policies to determine observations and goal information.

As discussed below, the predictive control application 106 may be configured to receive dynamic based data and environment based data to determine observations and goal information associated with operation of the ego agent 102 by a human driver. The predictive control application 106 may utilize a trained neural network that is trained in real-time with raw observations obtained from sensors as an input to extend a linear reward to a nonlinear reward without suffering from an increasing time complexity problem that may be seen with other approaches such as Gaussian processes. By training the neural network 108 with the raw observation obtained from sensors as an input, both the weight and the features are automatically obtained, so it does not require hand-designed state features.

Based on the training of the neural network 108, the predictive control application 106 may learn spatiotemporal costmaps that are based on the observations and goals associated with the operation of the ego agent 102 and the traffic environment that may be based on human operation of the ego agent 102 and one or more traffic agents that are located within the traffic environment. Each of the spatiotemporal costmaps represent each timestep's cost function associated with the ego agent's operation and state at each respective timestep in addition to the operation of one or more traffic agents that are located within the traffic environment. Upon learning the costmaps, the predictive control application 106 may be configured to output an optimal control policy and state trajectories that generates trajectories that are to be followed by the ego agent 102 within a particular traffic environment.

In other words, the predictive control application 106 completes costmap learning using assumptions that a kinematic bicycle model is followed by the ego agent 102 and a near-perfect state estimation of the ego agent 102 and of traffic agents may be within a perception range. In one or more embodiments, the predictive control application 106 may utilize Inverse Optimal Control (IOC) and/or Inverse Reinforcement Learning (IRL) to output the optimal control policy and state trajectories to generate future trajectories that may be utilized during autonomous operation of the ego agent 102 that are similar to those that may be utilized by a human operator that may have operated the ego agent 102.

The predictive control application 106 may be configured to provide commands to autonomously control the operation of the ego agent 102 within the traffic environment according to the optimal policy. Accordingly, the predictive control application 106 learns a cost function of operating the ego agent 102 within one or more particular driving environments (e.g., highways, local roads) from human demonstrations and/or real-time data captured at one or more past time-steps. The predictive control application 106 provides an improvement in the technology by utilizing goal-conditioned costmap learning to focus on which future state for an ego agent 102 to reach and improves learning performance and operational performance with respect to the operation of the ego agent 102 within various types of traffic environments.

With continued reference to FIG. 1, the ECU 104 may be configured to be operably connected to a plurality of additional components of the ego agent 102, including, but not limited to, the camera system 110, a LiDAR system 112, a storage unit 114, an autonomous controller 116, systems/control units 118, and dynamic sensors 120. In one or more embodiments, the ECU 104 may include a microprocessor, one or more application-specific integrated circuit(s) (ASIC), or other similar devices. The ECU 104 may also include internal processing memory, an interface circuit, and bus lines for transferring data, sending commands, and communicating with the plurality of components of the ego agent 102.

The ECU 104 may also include a communication device (not shown) for sending data internally within (e.g., between one or more components) the ego agent 102 and communicating with externally hosted computing systems (e.g., external to the ego agent 102). Generally, the ECU 104 may communicate with the storage unit 114 to execute the one or more applications, operating systems, system and subsystem user interfaces, and the like that are stored within the storage unit 114. For example, the ECU 104 may communicate with the storage unit 114 to execute the predictive control application 106.

In one embodiment, the ECU 104 may communicate with the autonomous controller 116 to execute autonomous driving commands to operate the ego agent 102 to be fully autonomously driven or semi-autonomously driven based on future states that are output for the ego agent 102 to reach based on the optimal policy. The optimal policy may be utilized to generate trajectories to be followed during autonomous operation of the ego agent 102 that may be similar to those that would be utilized if a human operator was to operate the ego agent 102 in a similar traffic environment that includes similar traffic agent positions, state space, action space, and the like.

As discussed, the autonomous driving commands may be based on commands provided by the predictive control application 106 to provide agent autonomous controls that may be associated with the ego agent 102 to navigate the ego agent 102 within the traffic environment based on future trajectories that may be determined based on the optimal control policy and state trajectories output through the execution of IOC and/or IRL. In other words, the autonomous driving commands may be based on commands provided by the predictive control application 106 to autonomously control one or more functions of the ego agent 102 to travel within the traffic environment based on the optimal control policy and state trajectories that may be based on the costmap associated with learned cost functions at a plurality of time steps of an operation of the ego agent 102.

In one configuration, one or more commands may be provided to one or more systems/control units 118 that include, but are not limited to an engine control unit, a braking control unit, a transmission control unit, a steering control unit, and the like to control the ego agent 102 to be autonomously driven based on one or more autonomous commands that are output by the predictive control application 106 to navigate the ego agent 102 within the traffic environment of the ego agent 102. In particular, one or more functions of the ego agent 102 may be autonomously controlled to travel within the traffic environment in a manner that may be based on the future states that are output for the ego agent 102 to reach based on the optimal policy that generates trajectories to be utilized during autonomous operation of the ego agent 102 that are similar to those that may mimic natural human operating behaviors.

In one or more embodiments, the systems/control units 118 may be operably connected to the dynamic sensors 120 of the ego agent 102. The dynamic sensors 120 may be configured to receive inputs from one or more systems, sub-systems, control systems, and the like. In one embodiment, the dynamic sensors 120 may be included as part of a Controller Area Network (CAN) of the ego agent 102 and may be configured to provide dynamic data to the ECU 104 to be utilized for one or more systems, sub-systems, control systems, and the like. The dynamic sensors 120 may include, but may not be limited to, position sensors, heading sensors, speed sensors, steering speed sensors, steering angle sensors, throttle angle sensors, accelerometers, magnetometers, gyroscopes, yaw rate sensors, brake force sensors, wheel speed sensors, wheel turning angle sensors, transmission gear sensors, temperature sensors, RPM sensors, GPS/DGPS sensors, and the like (individual sensors not shown).

In one configuration, the dynamic sensors 120 may provide dynamic data in the form of one or more values (e.g., numeric levels) that are associated with the real-time dynamic performance of the ego agent 102 as one or more driving maneuvers are conducted and/or as the ego agent 102 is controlled to be autonomously driven. As discussed below, dynamic data that is output by the dynamic sensors 120 may be associated with a real time dynamic operation of the ego agent 102 as it is traveling within the traffic environment. As discussed below, the dynamic data may be provided to the neural network 108 in the form of goal information that may be associated with the trajectory and operation of the ego agent 102 within the traffic environment at a plurality of time steps to be analyzed determine cost functions for each of the plurality of time steps.

With continued reference to FIG. 1, the camera system 110 of the ego agent 102 may include one or more of the cameras (not shown) that may be positioned in one or more directions and at one or more areas to capture one or more images of the traffic environment of the ego agent 102 (e.g., images of the roadway on which the ego agent 102 is traveling). The one or more cameras of the camera system 110 may be disposed at external front portions of the ego agent 102, including, but not limited to different portions of a dashboard, a bumper, front lighting units, fenders, and a windshield. In one embodiment, the one or more cameras may be configured as RGB cameras that may capture RGB bands that are configured to capture rich information about object appearance that pertain to roadway lane markings, roadway/pathway markers, and/or roadway/pathway infrastructure (e.g., guardrails).

In other embodiments, the one or more cameras may be configured as stereoscopic cameras that are configured to capture environmental information in the form of three-dimensional images. In one or more configurations, the one or more cameras may be configured to capture one or more first person viewpoint RGB images/videos of the current location of the ego agent 102 from the perspective of the ego agent 102. In one embodiment, the camera system 110 may be configured to convert one or more RGB images/videos (e.g., sequences of images) into image data that is communicated to the predictive control application 106 to be analyzed.

In an exemplary embodiment, the LiDAR system 112 may be operably connected to a plurality of LiDAR sensors (not shown). In particular, the LiDAR system 112 may include one or more planar sweep lasers that include respective three-dimensional LiDAR sensors that may be configured to oscillate and emit one or more laser beams of ultraviolet, visible, or near infrared light toward the scene of the surrounding environment of the ego agent 102. The plurality of LiDAR sensors may be configured to receive one or more reflected laser waves (e.g., signals) that are reflected off one or more objects such as surrounding vehicles located within the driving scene of the ego agent 102. In other words, upon transmitting the one or more laser beams to the driving scene, the one or more laser beams may be reflected as laser waves by one or more obstacles that include static objects and/or dynamic objects that may be located within the driving scene of the ego agent 102 at one or more points in time.

In one embodiment, each of the plurality of LiDAR sensors may be configured to analyze the reflected laser waves and output respective LiDAR data to the predictive control application 106. The LiDAR data may include LiDAR coordinates that may be associated with the locations, positions, depths, and/or dimensions (e.g., measurements) of one or more traffic agents that may be located within the dynamic environment.

As discussed below, in one embodiment, the image data and/or the LiDAR provided by the camera system 110 and/or the LiDAR system 112 may be provided to the predictive control application 106 to be utilized to train the neural network 108 with data that may represent observations associated with the traffic environment that include, but may not be limited to, the operation, position, and maneuvers completed by one or more traffic agents during a plurality of time steps. Such data may be utilized to train the neural network 108 and to thereby output cost functions associated each of the plurality of time steps.

In one embodiment, the neural network 108 may be hosted upon an external server 122 that may be owned, operated, and/or managed by an OEM, a third-party administrator, and/or a dataset manager that manages data that is associated with the operation of the predictive control application 106. The external server 122 may be operably controlled by a processor 124 that may be configured to execute the predictive control application 106. In particular, the processor 124 may be configured to execute one or more applications, operating systems, database, and the like. The processor 124 may also include internal processing memory, an interface circuit, and bus lines for transferring data, sending commands, and communicating with the plurality of components of the external server 122.

In one embodiment, the processor 124 may be operably connected to a memory 126 of the external server 122. Generally, the processor 124 may communicate with the memory 126 to execute the one or more applications, operating systems, and the like that are stored within the memory 126. In one embodiment, the memory 126 may store one or more executable application files that are associated with the predictive control application 106.

In an exemplary embodiment, the external server 122 may be configured to store the neural network 108. The neural network 108 may be configured as convolutional neural network (CNN) that may be configured as a U-Net type neural network architecture with skip connections. The neural network 108 may execute machine learning/deep learning techniques to process and analyze sequences of data points that pertain to observations associated with the traffic environment that include, but may not be limited to, the operation, position, and maneuvers completed by one or more traffic agents during a plurality of time steps and goals associated with the operation of the ego agent 102 and the traffic environment that may be based on human operation of the ego agent 102 and one or more traffic agents that are located within the traffic environment. The observations and goals may be determined based on human-annotated data that is pre-trained to the neural network 108 based on human observations and/or based on image data that is provided by the camera system 110, LiDAR data that is provided by the LiDAR system 112, and dynamic data that is provided by the dynamic sensors 120.

In an exemplary embodiment, the neural network 108 may be trained based on inputting of data associated with observations and goals as stored data points. The data points may be stored within records that are associated with the specific traffic environment in which the ego agent 102 is being operated and may categorized by particular time stamps for which each of the data points associated with the observations pertaining to various traffic agents and goals associated with the operation of the ego agent 102 are acquired. The stored data points of the machine learning dataset 128 may be utilized to train the neural network 108 and may be further analyzed and utilized to process cost functions that are associated with a plurality of time stamps that pertain to the observations and goals.

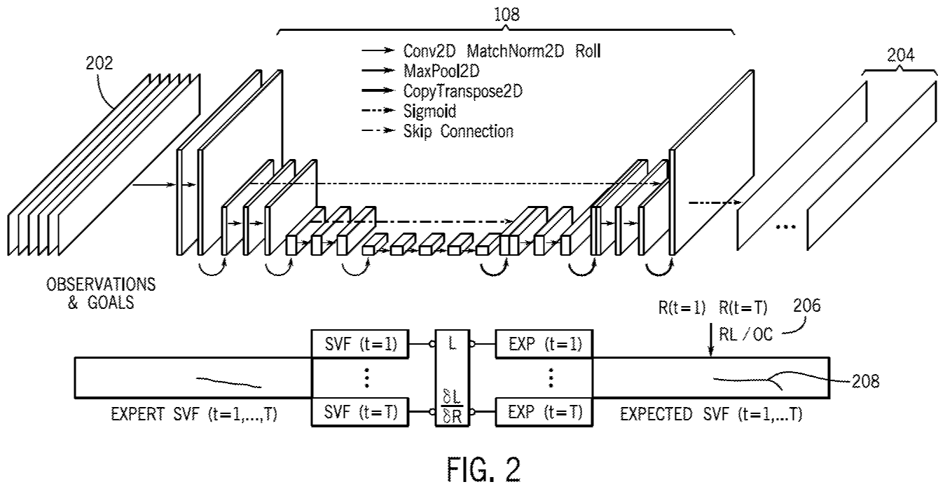

FIG. 2 is a schematic overview of a spatiotemporal costmap learning methodology executed by the predictive control application 106 according to an exemplary embodiment of the present disclosure. The predictive control application 106 may receive the image data, LiDAR data, and the dynamic data respectively from the camera system 110, the LiDAR system 112, and the dynamic sensors 120 of the ego agent 102. Such data may be analyzed and aggregated into observations and goals 202 that are associated with the traffic environment, the operation of traffic agents within the traffic environment, and the operation of the ego agent 102. In another embodiment, data that is based on real human observations that pertain to driving simulations may be provided as observations and goals 202.

As shown in FIG. 2, the observations and goals 202 may be inputted to the neural network 108 to train the neural network 108. In one configuration, the neural network 108 may be trained by populating the machine learning dataset 128 with data points that are associated with the observations and goals 202 at a plurality of time steps. In one configuration, the predictive control application 106 may be configured to utilize the neural network 108 to analyze the datapoints and process a bird's eye view 2D representations that are converted from the observations and goals and may utilize machine learning deep learning techniques to analyze the bird's eye view 2D representations. The neural network 108 may thereby output T costmaps 204, each representing each timestep's cost function associated with the ego agent 102 and the one or more traffic agents that are located within the traffic environment.

The predictive control application 106 may be configured to utilize analyze the T costmaps 204 and may utilize IOC and/or IRL to output an optimal policy 206 that may be executed to generate future trajectories 208 that may be utilized during autonomous operation of the ego agent 102 that are similar to those that may be utilized by a human operator that may have operated the ego agent 102. In particular, the neural network 108 may process an optimal path with the predicted costmap and State Visitation Frequencies (SVFs) to compute the optimal policy 206 that may be used to update neural network weights and to future trajectories 208 that may be utilized to autonomously control operation of the ego agent 102 at one or more future time steps (t+1, t+2, t+n).

### II. The Spatiotemporal Costmap Inference Model Predictive Control Application and Related Methods

Components of the predictive control application 106 will now be described according to an exemplary embodiment and with continued reference to FIG. 1. In an exemplary embodiment, the predictive control application 106 may be stored on the storage unit 114 and executed by the ECU 104 of the ego agent 102. In another embodiment, the predictive control application 106 may be stored on the memory 126 of the external server 122 and may be accessed by a telematics control unit (not shown) of the ego agent 102 to be executed by the ECU 104 of the ego agent 102.

The general functionality of the predictive control application 106 will now be discussed. In an exemplary embodiment, the predictive control application 106 may include a plurality of modules 130-134 that may be configured to provide spatiotemporal costmap inference for model predictive control. The plurality of modules 130-134 may include a data reception module 130, a costmap determinant module 132, and an agent control module 134. However, it is appreciated that the predictive control application 106 may include one or more additional modules and/or sub-modules that are included in lieu of the modules 130-134.

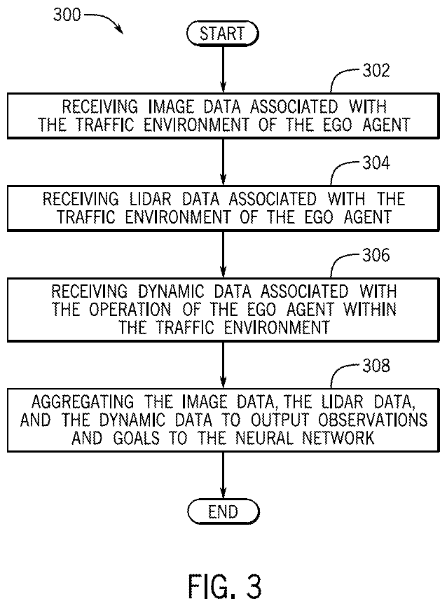

FIG. 3 is a process flow diagram for determining observations and goals that are to be input to the neural network 108 according to an exemplary embodiment of the present disclosure. FIG. 3 will be described with reference to the components of FIG. 1 and FIG. 2 though it is to be appreciated that the method 300 of FIG. 3 may be used with other systems/components. The method 300 may begin at block 302, wherein the method 300 may include receiving image data as environment based data that is associated with the traffic environment of the ego agent 102.

In an exemplary embodiment, at one or more past time steps and/or at a current time step, the data reception module 130 of the predictive control application 106 may be configured to communicate with the camera system 110 of the ego agent 102 to collect image data associated with untrimmed images/video of the driving scene of the ego agent 102 at a plurality of time steps (at past time steps and at the current time step) of the ego agent 102.

In some configurations, the image data may pertain to one or more first person viewpoint RGB images/videos of the driving scene of the ego agent 102 captured at particular time steps. The image data may be configured to include rich information about object appearance that pertain to roadway lane markings, roadway/pathway markers, roadway/pathway infrastructure within the driving scene of the ego agent 102 at one or more time steps. In some embodiments, the data reception module 130 may package and store the image data on the storage unit 114 to be evaluated at one or more points in time.

The method 300 may proceed to block 304, wherein the method 300 may include receiving LiDAR data as environment based data that is associated with traffic environment of the ego agent 102. In an exemplary embodiment, the data reception module 130 may communicate with the LiDAR system 112 of the ego agent 102 to collect LiDAR data that includes LiDAR based observations from the ego agent 102. The LiDAR based observations may indicate the location, range, and positions of the one or more traffic agents off which the reflected laser waves were reflected with respect to a location/position of the ego agent 102. In some embodiments, the data reception module 130 may package and store the LiDAR data on the storage unit 114 to be evaluated at one or more points in time.

The method 300 may proceed to block 306, wherein the method 300 may include receiving dynamic data as dynamic based data that is associated with the operation of the ego agent 102 within the traffic environment. In an exemplary embodiment, the data reception module 130 may communicate with the dynamic sensors 120 of the ego agent 102 to collect dynamic data that pertains to the dynamic performance of the ego agent 102 as one or more driving maneuvers are conducted and/or as the ego agent 102 at a current time step and one or more past time steps. The dynamic data that is output by the dynamic sensors 120 may be associated with a dynamic operation of the ego agent 102 as it is traveling within the traffic environment at a plurality of time steps.

The method 300 may proceed to block 308, wherein the method 300 may include aggregating the image data, the LiDAR data, and the dynamic data to input observations and goals to the neural network 108. In an exemplary embodiment, the data reception module 130 may be configured to aggregate the image data that may include rich information about object appearance that pertain to roadway lane markings, roadway/pathway markers, and/or roadway/pathway infrastructure within the locations of the ego agent 102 at one or more time steps, the LiDAR data that pertains to LiDAR based observations may indicate the location, range, and positions of the one or more traffic agents, and the dynamic data that is associated with the dynamic operation of the ego agent 102 as it is traveling within the traffic environment at a plurality of time steps.

Upon aggregation of the image data, the LiDAR data, and the dynamic data, the data reception module 130 may communicate the aggregated data to costmap determinant module 132 of the predictive control application 106. In one embodiment, the costmap determinant module 132 maybe configured to analyze the aggregated data and may extract data associated with observations and goals 202 that are associated with the ego agent 102 and the traffic environment that are determined based on dynamic based data and environment based data. Such observations and goals 202 may be associated with the traffic environment, the operation of traffic agents within the traffic environment, and the operation of the ego agent 102.

In an exemplary embodiment, upon determining the observations and goals 202 for a plurality of time steps, the costmap determinant module 132 may be configured to input the observations and goals 202 to the neural network 108 to train the neural network 108. In another embodiment, in addition to or in lieu of the utilization of the image data, LiDAR data, and dynamic data, data that is based on real human observations that pertain to driving simulations may be determined as observations and goals 202 that are input by human annotators to the predictive control application 106 and/or the machine learning dataset 128 to train the neural network 108. As discussed above, the neural network 108 may be trained by populating the machine learning dataset 128 with data points that are associated with the observations and goals 202 at a plurality of time steps.

In an exemplary embodiment, by training the neural network 108 with the observations and goals 202, both a weight and features are automatically obtained. In one embodiment, the neural network 108 may be trained to maximize the joint probability of the sensor based data or demonstration data D and model parameters θ under the estimated reward R(θ):

L(ë)=log P(D,ë|R(ë))

=log P(D|R(θ))+log P(θ)=L_{D}+∠θ

Since ∠θ may be optimized with weight regularization techniques for training NNs, the neural network 108 may maximize the first term L_{D}:

$$\frac{\partial {L}_{D}}{\partial \ddot{e}} = \frac{\partial {L}_{D}}{\partial R} \frac{\partial R}{\partial \ddot{e}} = {f}_{D} - E [ f ]$$

$$= ( {μ}_{D} - E [ μ ] ) {F}_{s} = ( {μ}_{D} - E [ μ ] ) \frac{\partial R ( \ddot{e} )}{\partial \ddot{e}}$$

where F_{S} is a matrix that maps states to state features and the back-propagation of the reward with respect to the weights,

$$\frac{\partial R ( \ddot{e} )}{\partial \ddot{e}} ,$$

replaces F_{S}.

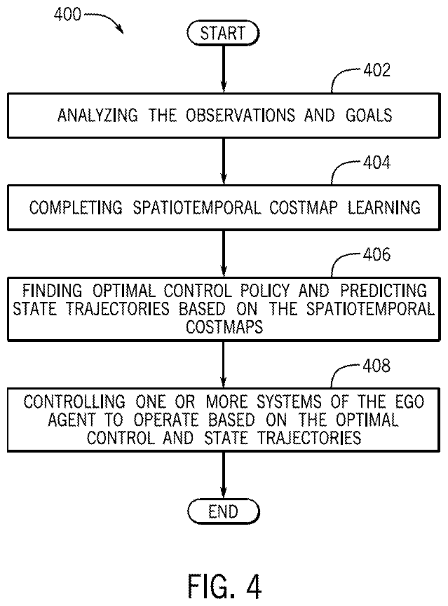

FIG. 4 is a process flow diagram of a method 400 for determining an optimal control policy that is based on determined by spatiotemporal costmap inference according to an exemplary embodiment of the present disclosure. FIG. 4 will be described with reference to the components of FIG. 1 and FIG. 2 though it is to be appreciated that the method 400 of FIG. 4 may be used with other systems/components. The method 400 may begin at block 402, wherein the method 400 may include analyzing the observations and goals 202. In an exemplary embodiment, the neural network 108 may access the machine learning dataset 128 and access data associated with the observations and goals 202 previously trained to the neural network 108. As discussed above, the observations and goals 202 may be trained to the neural network 108 based on the aggregation of image data, LiDAR data, and dynamic data and/or based on real human observations that pertain to driving simulations may be determined based on input of observations and goals 202 by human annotators.

In one embodiment, the neural network 108 may be configured to analyze the data points associated with the observations and goals 202 and normalize the data points into a bird's eye view 2D representations of the traffic environment that include the positions of the ego agent 102 and the traffic agents that are located within the traffic environment at a plurality of time steps. The bird's eye view 2D representations may also include goal information such as a goal lane which is a future heading/destination of the ego agent 102. The neural network 108 provides the bird's eye view 2D representations to account for the varying size of the number of traffic agents within the traffic environment.

In an exemplary embodiment, the costmap determinant module 132 of the predictive control application 106 may be configured to utilize the neural network 108 to execute machine learning/deep learning techniques to approach the processing of a costmap as an inference problem and a trajectory optimization problem. The inference problem may be defined as a reward/cost function of the ego agent 102. Given an observation Oₜ(sₜ) goal g, and an expert demonstration data sₜ, . . . , t+T, the module 132 is configured to find Rₜ(sₜ|g) that best explains sₜ, . . . , t+T. The trajectory problem may be defined as: given sₜ, Oₜ(sₜ), g, and Rₜ(sₜ|g), find the optimal path and control trajectory that maximizes R.

The neural network 108 may evaluate the operation of the ego agent 102 as following the kinematic bicycle model (referenced below). The neural network 108 may evaluate the ego agent 102 and the traffic agents located within the traffic environment within a perception range. When the observations and goals 202 are determined based on human annotations pertaining on real human observations that pertain to driving simulations, an assumption may be made that a near-perfect state estimation of the ego agent 102 and the traffic agents within a perception range. The observations and goals 202 may be evaluated as showing optimal agent operating behavior within the traffic environment.

Using IRL, a discrete-time version of the kinematic bicycle model that may be used for modeling the ego agent 102 and computing control actions for other baseline methods may be executed as:

$${β}_{k} = {tan}^{- 1} ( \frac{{l}_{r}}{{l}_{f} + {l}_{r}} tan ( {δ}_{k} ) )$$

$${x}_{k + 1} = {x}_{k} + {v}_{k} cos ( {ψ}_{k} + {B}_{k} ) Δ t$$

$${y}_{k + 1} = {y}_{k} + {v}_{k} sin ( {ψ}_{k} + {B}_{k} ) Δ t$$

$${ψ}_{k + 1} = {ψ}_{k} + \frac{{v}_{k}}{{l}_{r}} sin ( {β}_{k} ) Δ t$$

$${v}_{k + 1} = {v}_{k} + {a}_{k} Δ t$$

where α and δ are the control inputs: acceleration and the front wheel steering angle, β is the angle of the current velocity of the center of mass with respect to the longitudinal axis of the ego agent 102, (x, y) are the position, the coordinates of the center of mass in an inertial frame (X, Y), ν is the inertial heading angle, and v is the vehicle speed. lᵣ and l_{f} are the distance from the center of the mass to the front and rear of the vehicle, respectively.

In one embodiment, the neural network 108 may execute goal-conditioned IRL to determine which state to reach using goal information to provide goal conditioned costmap learning by specifying the goal and learning. The learned costmap may exclude artifacts and noise for unvisited states and may predict a high cost for unvisited states. This approach allows the costmap to have less noise and artifacts and thus provides a less false positive error which may result in better interpretability for both humans and optimal controllers.

In one embodiment, a loss term: L_{zero}=˜(μ_{D}+E[μ]) which minimizes the reward or maximizes the cost for unvisited states. The (˜) represents a NOT operator. Accordingly, supervised learning is utilized which has labels of 0 (low) reward for unvisited states, leveled by the demonstration and the learner's expected SVF. The total loss with this zeroing loss is defined as:

L(θ)=L_{D}+L_{θ}+c_{zero}L_{zero}

with a constant c_{zero}. To balance with other losses, the neural network 108 may choose c_{zero}=T/(costmap size), where T are the number of timesteps in the costmap and the costmap size is its width X height. The additional zeroing loss is minimized in a normal way of loss backpropagation as it has labels of 0 (reward) for unvisited states.

With continued reference of the method 400 of FIG. 4, the method 400 may proceed to block 404, wherein the method 400 may include completing spatiotemporal costmap learning. In an exemplary embodiment, the costmap determinant module 132 may utilize the neural network 108 to learn and output the spatiotemporal costmaps 204. Given the observation Oₜ and the goal information g, the costmap model takes the representation as an input and predicts T concatenated position costmaps Jₚ(xₜ₊₁, y_{t+1,}|Oₜ, g), . . . , Jₚ(x_{T}, y_{t+1,}|Oₜ, g) at once, where Jₚ is the position cost (map). The dimension of the output of the model is T, width, height.

The method 400 may proceed to block 406, wherein the method 400 may include finding optimal control policy and predicting state trajectories based on the spatiotemporal costmaps. In an exemplary embodiment, the costmap determinant module 132 may communicate data pertaining to the costmaps to the agent control module 134 of the predictive control application 106. The agent control module 134 may be configured to execute an optimal controller that finds optimal control and state trajectories with respect to the predicted costmaps. Given the reward from IRL, the forward IRL problem may be formulated in discreate time stochastic optimal control settings, where the agent model is stochastic., i.e., disturbed by Brownian motion entering into a control channel, and the agent control module 134 may find an optimal control sequence u* such that:

$${u}^{*} ( \cdot ) = arg min E [ ∅ ( s ( T ) \vert {O}_{o} , g ) + {\sum }_{t = 0}^{T - 1} ℒ ( {s}_{t} , {u}_{t} \vert {O}_{o} , g ) ]$$

where the expectation is taken with respect to dynamics with control u having an additive Brownian noise [symbol] (O, Σ). A variable s may denote the state (x, y, ψ, ν, β) and may use the position (x, y) as a cost function to perform a task that Is denoted as [symbol] :

[symbol]

(sₜ,uₜ|O₀,g)= [symbol] (sₜ|O₀,g)=Jₚ(xₜ,yₜ|O₀,g)

where Jₚ(x,y|O₀,g) is the goal-conditioned position costmap. The final state cost φ(s(T)|O0,g) may be defined as:

[symbol]

(s(T)|O₀,g)=c_{T}Jₚ(x_{T},yτ|O₀,g)

where c_{T} is a constant value.

In an exemplary embodiment, the agent control module 134 may be configured to use model predictive control (MPC) to find the optimal control and state trajectories with respect to the predicted costmaps. The agent control module 134 may be configured to sample a large number of Brownian noise [symbol] (0,Σ) sequence, inject them to the control channels, forward propagate the dynamics with the sequence of control+sampled noise. The agent control module 134 may utilize MPC to further compute the cost defined in

$${u}^{*} ( \cdot ) = arg min E [ ∅ ( s ( T ) \vert {O}_{o} , g ) + {\sum }_{t = 0}^{T - 1} ℒ ( {s}_{t} , {u}_{t} \vert {O}_{o} , g ) ]$$

and put more weights on ‘good’ noise sequences that resulted in a low cost and may further update the control sequence with weighted noise sequence. The module 134 may iterate the process until convergence and thereby execute the first h-timestep's control action to generate future trajectories 208 that may be utilized during autonomous operation of the ego agent 102 that are similar to those that may be utilized by a human operator that may have operated the ego agent 102.

In one embodiment, waypoints may be extracted from low cost regions of each timestep's costmap by finding average positions (x̅, y) of the low cost regions. A complex optimization problem with physical constraints that are based on dynamics of the ego agent 102 as determined by dynamic data provided by the dynamic sensors may be formulated to ensure that the costmap extracted average waypoints (x̅, y̅) are smoothened. In one configuration, the costmap extracted average waypoints (x̅, y̅) are incorporated as a state reference and consequently the problem is aligned with a formal reference tracking problem by which a Quadratic Programming (QP) solver may be applicable. The convex problem may read as:

min Jₚ(x,y,x,y)=min ADS((x,y),(x,y))

where, u ∈ [uₘᵢₙ, uₘₐₓ] and where the position state (x, y) is a function of control u=(δ, α), shown in the kinematic bicycle model and the Average Displacement Error (ADE) is defined as:

$$A D E ( ( x , y ) , ( x , y ) ) = {\sum }_{t = 1}^{T} \frac{{‖ ( {x}_{t} , {y}_{t} ) - ( {x}_{t} , {y}_{t} ) ‖}_{2}}{T} .$$

The agent control module 134 may utilize additional cost terms in MPC to ensure smoothness during autonomous control of the ego agent 102. The learned costmap may be used as one of the costs that MPC optimizes to perform a task. However, additional factors may be accounted for during the real-world autonomous operation other than the goal task (lane changing, lane keeping, etc.) completion, for example, user comforts. In one configuration, control and control rates costs may penalize the throttle, brake, steering angle, and their changes to provide less jerky and abrupt behavior. The total cost with extra control-related costs may be written as:

J=cₚJₚ(x,y)+c_{α}J_{α}(α)+c_{\dot{α}}J_{\dot{α}}(\dot{α})

where Jₚ is the task-related position cost that we learn and J_{α} penalizes the control, throttle and steer, J_{\dot{α}} penalizes their derivatives (i.e., jerk and steering rate) in mean squared error (MSE). Each cost term may be weighted by users with cₚ, c_{α}, and c_{\dot{α}}.

In one embodiment, to ensure the recursive feasibility of MPC with respect to the spatiotemporal costmap, if at the kth timestep, if the waypoint moves in a reverse direction or if the waypoint does not exist, the waypoints after the kth waypoint, including k may be ignored. The agent control module 134 may only use the waypoints up to the (k-1)th waypoints to ensure that there is no overlap between the future path of the ego agent 102 and the paths of any of the traffic agents that are located within the traffic environment.

Additionally, the agent control module 134 may add an extra safety check pipeline on top of the IRL MPC framework. The safety check pipeline may use the same information, the traffic agents' state information, that may be used to predict each cost function and may check whether the MPC predicted state trajectory of the ego agent 102 will potentially overlap with each traffic agent's predicted state trajectory within a particular margin. This may be accomplished by simulating each traffic agents projected trajectory for T timesteps with a constant velocity model. Accordingly, based on the simulations, if the agent control module 134 detects possible overlap between the kth (k≤T) timestep's MPC predicted ego states and each traffic agent's states, the module 134 may simply execute k−1 steps of the MPC control sequence.

The method 400 may proceed to block 408, wherein the method 400 may include controlling one or more systems of the ego agent 102 to operate based on the optimal control and state trajectories. In an exemplary embodiment, the agent control module 134 may be configured to analyze the optimal control and state trajectories for the ego agent 102 and each traffic agents projected trajectory for T timesteps. The agent control module 134 may be configured to communicate with the autonomous controller 116 to autonomously control one or more operating functions of the ego agent 102 based on the optimal control and state trajectories. Accordingly, the ego agent 102 may be autonomously controlled to operate to follow the generated future trajectories 208 that may be utilized that are similar to those that may be utilized by a human operator that may have operated the ego agent 102 in the particular traffic environment.

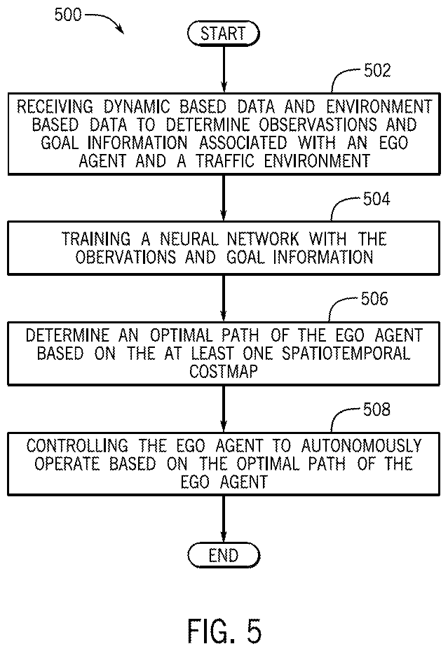

FIG. 5 is a process flow diagram of a method 500 for providing spatiotemporal costmap inference for model predictive control according to an exemplary embodiment of the present disclosure. FIG. 5 will be described with reference to the components of FIG. 1 and FIG. 2 though it is to be appreciated that the method 500 of FIG. 5 may be used with other systems/components. The method 500 may begin at block 502, wherein the method 500 may include receiving dynamic based data and environment based data to determine observations and goal information associated with an ego agent 102 and a traffic environment.

The method 500 may proceed to block 504, wherein the method 500 may include training a neural network with the observations and goal information 202. In one embodiment, at least one spatiotemporal costmap 204 is output by the neural network 108 based on the observations and goal information 202. The method 500 may proceed to block 506, wherein the method 500 may include determining an optimal path of the ego agent 102 based on the at least one spatiotemporal costmap 204. The method 500 may proceed to block 508, wherein the method 500 may include controlling the ego agent 102 to autonomously operate based on the optimal path of the ego agent 102.

It should be apparent from the foregoing description that various exemplary embodiments of the disclosure may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optimal storage media, flash-memory devices, and similar storage media.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

It will be appreciated that various implementations of the above-disclosed and other features and functions, or alternatives or varieties thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A computer-implemented method for providing spatiotemporal costmap inference for model predictive control comprising:
receiving dynamic based data and environment based data to determine observations and goal information associated with an ego agent and a traffic environment;
training a neural network with the observations and goal information, wherein at least one spatiotemporal costmap is output by the neural network based on the observations and goal information;
determining an optimal path of the ego agent based on the at least one spatiotemporal costmap; and
controlling the ego agent to autonomously operate based on the optimal path of the ego agent.

2. The computer-implemented method of claim 1, wherein receiving dynamic based data and environment based data includes receiving image data, LiDAR data, and dynamic data from components of the ego agent.

3. The computer-implemented method of claim 2, wherein the image data, LiDAR data, and dynamic data are aggregated to determine the observation and goal information.

4. The computer-implemented method of claim 1, wherein a bird's eye view two-dimensional representations are output to represent the traffic environment that include positions of the ego agent and at least one traffic agent that are located within the traffic environment at a plurality of time steps, wherein the representations may also include goal information that includes a future heading of the ego agent.

5. The computer-implemented method of claim 4, wherein cost functions that pertain to the operation of the ego agent and at least one traffic agent that is being operated within the traffic environment are determined for each of the plurality of time steps.

6. The computer-implemented method of claim 1, wherein determining the optimal path of the ego agent includes executing goal-conditioned Inverse Reinforcement Learning to determine which state to reach using goal information to provide goal conditioned costmap learning.

7. The computer-implemented method of claim 6, wherein determining the optimal path of the ego agent includes executing Model Predictive Control to find optimal control and state trajectories based on the at least one spatiotemporal costmap.

8. The computer-implemented method of claim 7, further including analyzing the state information of the ego agent and state information of the at least one traffic agent to determine whether the predicted state trajectory of the ego agent potentially overlaps with predicted state trajectory of the at least one traffic agent, wherein k-1 steps of the Model Predictive Control execution is executed when the potential overlap is determined.

9. The computer-implemented method of claim 7, wherein controlling the ego agent incudes analyzing the optimal control and state trajectories and communicating with an autonomous controller of the ego agent to autonomously control at least one operating function of the ego agent based on the optimal control and state trajectories.

10. A system for providing spatiotemporal costmap inference for model predictive control comprising:
a memory storing instructions when executed by a processor cause the processor to:
receive dynamic based data and environment based data to determine observations and goal information associated with an ego agent and a traffic environment;
train a neural network with the observations and goal information, wherein at least one spatiotemporal costmap is output by the neural network based on the observations and goal information;
determine an optimal path of the ego agent based on the at least one spatiotemporal costmap; and
control the ego agent to autonomously operate based on the optimal path of the ego agent.

11. The system of claim 10, wherein receiving dynamic based data and environment based data includes receiving image data, LiDAR data, and dynamic data from components of the ego agent.

12. The system of claim 11, wherein the image data, LiDAR data, and dynamic data are aggregated to determine the observation and goal information.

13. The system of claim 10, wherein a bird's eye view two-dimensional representations are output to represent the traffic environment that include positions of the ego agent and at least one traffic agent that are located within the traffic environment at a plurality of time steps, wherein the representations may also include goal information that includes a future heading of the ego agent.

14. The system of claim 13, wherein cost functions that pertain to the operation of the ego agent and at least one traffic agent that is being operated within the traffic environment are determined for each of the plurality of time steps.

15. The system of claim 10, wherein determining the optimal path of the ego agent includes executing goal-conditioned Inverse Reinforcement Learning to determine which state to reach using goal information to provide goal conditioned costmap learning.

16. The system of claim 15, wherein determining the optimal path of the ego agent includes executing Model Predictive Control to find optimal control and state trajectories based on the at least one spatiotemporal costmap.

17. The system of claim 16, further including analyzing the state information of the ego agent and state information of the at least one traffic agent to determine whether the predicted state trajectory of the ego agent potentially overlaps with predicted state trajectory of the at least one traffic agent, wherein k-1 steps of the Model Predictive Control execution is executed when the potential overlap is determined.

18. The system of claim 16, wherein controlling the ego agent incudes analyzing the optimal control and state trajectories and communicating with an autonomous controller of the ego agent to autonomously control at least one operating function of the ego agent based on the optimal control and state trajectories.

19. A non-transitory computer readable storage medium storing instruction that when executed by a computer, which includes a processor perform a method, the method comprising:
receiving dynamic based data and environment based data to determine observations and goal information associated with an ego agent and a traffic environment;
training a neural network with the observations and goal information, wherein at least one spatiotemporal costmap is output by the neural network based on the observations and goal information;
determining an optimal path of the ego agent based on the at least one spatiotemporal costmap; and
controlling the ego agent to autonomously operate based on the optimal path of the ego agent.

20. The non-transitory computer readable storage medium of claim 19, wherein controlling the ego agent incudes analyzing optimal control and state trajectories and communicating with an autonomous controller of the ego agent to autonomously control at least one operating function of the ego agent based on the optimal control and state trajectories.
